(19) United States
(12) Patent Application Publication
(10) Pub. No.: US 2013/0174759 A1
(43) Pub. Date: Jul. 11, 2013

(54) ROAD MATERIAL COMPOSITIONS, SYSTEMS AND METHODS OF MAKING

(71) Applicant: Pronghorn Environmental Technologies LLC, Henderson, NV (US)

(72) Inventor: Mark Stephen Winkelman, Cedar Hill, TX (US)

(73) Assignee: Pronghorn Environmental Technologies LLC, Henderson, NV (US)

(21) Appl. No.: 13/738,778

(22) Filed: Jan. 10, 2013

Related U.S. Application Data
(60) Provisional application No. 61/585,121, filed on Jan. 10, 2012.

(51) Int. Cl. C08L 95/00

(52) U.S. Cl. CPC C08L 95/00
USPC 106/278; 422/243

(57) ABSTRACT

Road material compositions, systems for uses and methods of making are provided in which the road material includes an asphaltene mixture. The asphaltene mixture generally includes at least one of the following: a surfactant, peptizer, stabilizer and light end hydrocarbons. The asphaltene mixture is combined with waste cuttings from a drill site and an aggregate to form a road-based material. The road-based material, thus, re-uses drill cuttings waste avoiding its disposal and the high costs associated with disposal. The road-based material is suitable for high and low traffic roads, oil roads, black top, as a patch mix and as a road base. The asphaltene mixture and the road-based material when formed are capable of immediate use as well as long-term storage. The asphaltene mixture and road-based material may both be readily modified for small and large scale production.

### CROSS REFERENCE TO RELATED APPLICATIONS

This application claims the benefit of U.S. Provisional Application No. 61/585,121 filed Jan. 10, 2012, which is incorporated herein by reference in its entirety.

### BACKGROUND

With re-use of a waste material, consumption and cost of a new material are reduced as are the cost of processing and storing waste. In the exploration and production of energy, such as oil and natural gas, drilling fluids are added to assist in the drilling of holes in the earth. In such drilling processes, drill cuttings, made up of ground materials including sand and shale (and which may also contain natural gases, hydrocarbons, heavy metals, minerals, and other natural fluids), are removed from the bore holes along with the added drilling fluids and are considered a type of waste. The drill cuttings when removed from the drill holes are further processed to separate much of the drilling fluids in order to re-use the valuable fluids; however, as much as 20 or 30 percent of the drilling fluids may remain in the drill cuttings after the separation process. Drilling fluids themselves, which are water-based, gel-based, oil-based, or polymer-based mixtures of materials, may contain environmentally harmful materials.

Because various components of drill cuttings are often considered hazardous to the environment, drill cutting that are removed from a drill hole may be unsuitable for other purposes. These drill cuttings, considered waste, are generally required to be transported to a permitted facility.

Ideally, waste drill cuttings containing drilling fluid would be treated to remove the hazardous constituents to an acceptable level. Most often, however, the waste cuttings are disposed of (generally to a landfill).

Typically, at a permitted facility waste drill cuttings are processed in order to try to “stabilize” the waste. In such processing, the addition of new “stabilizing” materials, such as a cement binder, fly ash, blast furnace slag, lime or calcium oxide, are generally introduced to solidify and retain the hazardous components, such as hydrocarbons, heavy metals and the like, in the solidified cuttings. Thus, a common practice is to either pre-treat the cuttings with such a binder material (and other materials) or to solidify cuttings (often initially pre-treated) in order to store the waste cuttings in a monolithic solid using a high strength material (e.g., hardened cement). Blocks of hardened solids may be prepared by this process, which are considered easy to dispose of and store. There is generally little chemical interaction between the waste and the binder material used to solidify the waste. Because of the high concentration of certain compounds in the waste cuttings or its very high pH or high organic content, the solidification process does not often produce monolithic blocks that maintain a high strength or are suitable for re-use. This is, in part, because of leaching out of one or more of the hazardous components or the breakdown of the solid matrix over time. Thus, after solidification, the formed solid is often landfilled. Some may be used for backfill but often in contained areas because of leaching out of the hazardous components. In addition, for many solidification processes, the waste cuttings require significant (time consuming and costly) pre-treatment, which can also produce a large of amount of unusable waste. Moreover, some solidification processes (e.g., other standard processes relying on cement, fly ash, other cementitious binder material) may not meet state or federal regulatory requirements and/or environmental standards.

The presence of hazardous contaminants, including hydrocarbons, in removed drill cuttings has hindered the re-use of waste cuttings.

### Overview

Described herein is a new and improved composition, system and process for the re-use of waste cuttings.

At least one composition described herein is an asphaltene-based composition comprising at least an asphaltene and a surfactant, the combination provided in an aqueous or non-aqueous homogenized mixture. The asphaltene is not asphalt. The asphaltene is the insoluble component or precipitate after dilution of crude oil with an n-alkane. The asphaltene generally has a penetration grade from about 0 to 25 or may be 20 pen or less. The asphaltene may comprise 50% to 80% of the composition by weight. The composition may further comprise light end hydrocarbons. The composition may further comprise naptha. The composition may further comprise one or more stabilizers. The composition may further comprise a peptizer, which is in the form of or includes a nitrogen-based resin. The surfactant may be a cationic surfactant, an anionic surfactant or a non-ionic surfactant. The composition may further comprise a peptizer, which is in the form of a nitrogen-based resin or a liquid rosin. The peptizer may include or act as a solvent. The mixture when formed is stable at room temperature.

Still further, described herein is an asphaltene composition comprising an asphaltene, and a peptizer that includes or acts as a solvent, the combination provided in an aqueous or non-aqueous homogenized mixture. The asphaltene is not asphalt. The asphaltene is the insoluble component or precipitate after dilution of crude oil with an n-alkane. The asphaltene may comprise 50% to 80% of the composition by weight. The composition may further comprise light end hydrocarbons. The composition may further comprise naptha. The composition may further comprise one or more stabilizers. The asphaltene is about 25 pen or less. The composition may further comprise a cationic surfactant. The peptizer may be a liquid rosin. The peptizer may be in the form of a nitrogen-based resin. The composition forms a stable mixture at room temperature. The composition is generally milled to form particulates of 1 to 50 microns.

In one or more forms, described herein is an asphaltene composition comprising an asphaltene, a surfactant; and a peptizer, the combination provided as an aqueous or non-aqueous homogenized mixture. The asphaltene is not asphalt. The asphaltene is the insoluble component or precipitate after dilution of crude oil with an n-alkane. The asphaltene may be about 25 pen or less. The aqueous or non-aqueous mixture is stable at room temperature and may be stored for over one year. The peptizer may be a nitrogen-based resin. The peptizer may be a liquid rosin. The peptizer may act as a solvent. The composition may further comprise light end hydrocarbons. The composition may further comprise a stabilizer. The composition is generally milled to form particulates of 1 to 50 microns.

Embodiments described herein further include methods of making an asphaltene composition. In one or more forms, the method comprises combining an asphaltene with at least a peptizer as a suspension, circulating the combination while maintaining heat and blending to form a homogenized mixture. In additional embodiments, the method comprises combining an asphaltene with at least a peptizer as a suspension, circulating the combination while maintaining heat, adding a surfactant, and blending to form a mixture. Still additional embodiments include a method that provides an asphaltene as a suspension, heating the suspension, adding at least a surfactant, and blending to form a homogenized mixture. In said methods, the asphaltene is not asphalt. The asphaltene is the insoluble component or precipitate after dilution of crude oil with an n-alkane. In the methods described, the methods may include blending at an elevated temperature followed by cooling to a reduced temperature after blending which, in one form, is believed to expand bonding sites in the blended mixture for later interaction with waste cuttings. The cooling is typically immediately or very shortly after exiting the blending step. Moreover, it is believed that the cooling prevents certain components in the mixture from degrading thereby reducing the initial amount of such components required in the initial formulation. The blending may include blending with a colloid mill to form a homogenized mixture with particulates of 1 to 50 microns.

A composition for use as a road based material is also described, the composition comprising an asphaltene mixture as described herein, waste cuttings from a drill site and one or more aggregates, wherein the aggregates are or include rock, sand, gravel, an asphalt concrete, cement binder and/or epoxy binder. The asphaltene is not asphalt. The asphaltene is the insoluble component or precipitate after dilution of crude oil with an n-alkane. The asphaltene mixture may further comprise one or more of the group consisting of peptizer, surfactant, stabilizer, and light end hydrocarbon. The waste cuttings may include one or more of water, oil or polymer-based drilling fluids. The one or more aggregates may be selected from one or more of a black base, sand, gravel, an asphalt concrete mix, clay, a cementitious binder, cement or an epoxy binder. The composition when combined is used for one or more of a high traffic road, low traffic road, oil road, black top, as a patch mix and/or a road base. The composition when combined is used in a high temperature and a low temperature environment. The composition when combined may be laid out in a mat or lift or pile. The composition when combined is available for long term storage or for immediate use.

A method of making a road-base material is further described herein, the method generally comprising combining an asphaltene mixture, waste cuttings from a drill site and one or more aggregates, wherein the aggregate is or includes one or more of rock, sand, gravel, shale, black base, an asphalt concrete mix, clay, cementitious binder and/or epoxy binder. The asphaltene mixture is a homogenized mixture that includes asphaltene provided initially as an insoluble component or precipitate after dilution of crude oil with an n-alkane. Combining may include adding the components in a mixer. Combining may be performed in one of a pug mill, paddle mixer, continuous mixer, batch mixer, concrete mixer, truck mixer, muller type mixer, and pan mixer. Combining may be performed at ambient temperature. The waste cuttings are provided in a range from about 20 to about 60%. The waste cuttings may also be in an amount less than 30%. The asphaltene mixture is provided in a range from about to 0.05 to about 10%.

Still further is a system for preparing a road-based material. The system comprises an asphaltene mixture, wherein the asphaltene mixture is a homogenized mixture that includes asphaltene provided initially as an insoluble component or precipitate after dilution of crude oil with an n-alkane; waste cuttings from a drill site; and one or more aggregates, wherein the one or more aggregates are or include one or more of a black base, sand, shale, clay, gravel, an asphalt concrete mix, a cementitious binder, cement or epoxy binder; and the system also includes a mixer. The system is provided on location. The waste cuttings often do not require additional treatment prior to use.

Those skilled in the art will further appreciate the above-mentioned advantages and superior features of the invention together with other important aspects thereof upon reading the detailed description which follows in conjunction with the drawings.

### BRIEF DESCRIPTION OF THE DRAWINGS

For more complete understanding of the features and advantages of the inventions described herein, reference is now made to a description of the invention along with accompanying figures, wherein:

FIG. 1 is a representative process as described herein;

FIG. 2 is another representative process as described herein.

### DETAILED DESCRIPTION

Although making and using various embodiments are discussed in detail below, it should be appreciated that as described herein are provided many inventive concepts that may be embodied in a wide variety of contexts. Embodiments discussed herein are merely representative and do not limit the scope of the invention.

The drawing figures are not necessarily to scale and certain features may be shown exaggerated in scale or in somewhat generalized or schematic form in the interest of clarity and conciseness. In the following description, like numbers refer to like elements.

In one form, described herein is a composition for mixing with and for re-using waste cuttings. Said waste cuttings will include drilling fluid that is water-based, oil-based, and/or polymer-based. Accordingly, the composition described herein will be suitable with as well as compatible with known drilling fluids. At least one composition described herein will couple with and/or complex with waste cuttings and the components therein, including hydrocarbons contained in the waste cuttings, thereby forming a new composition capable of stabilizing said waste cuttings, such as for recycling and/or to be available for an additional use.

The at least one composition described is, in one form, initially prepared in the absence of waste cuttings. Said composition generally includes one or more of an asphaltene, surfactant, peptizer, light-end hydrocarbon and stabilizer. As will be further described, in some embodiments, one or more of the components may be omitted. The omission of one or more ingredients of the asphaltene-based composition will not prevent the composition from suitably mixing with waste cuttings and, when mixed, the omission of one or more ingredients of the composition will not prevent the mixed waste cuttings from being available for an additional use, as will be described further.

When formed, an asphaltene based composition described herein is stable at room temperature. Generally, the asphaltene based composition when formed or during formation is sheared or otherwise broken into particle sizes. The particle sizes are, on average, 50 micrometers in diameter or less than 50 micrometers in diameter. In one or more forms, the particle size is in a range from about 5 microns to about 20 microns or up to about 25 microns or up to about 30 microns or up to about 35 microns or up to about 40 microns.

An asphaltene as used herein is distinguishable from and is not asphalt. While asphalt, also described as bitumen, may contain asphaltenes, asphalt when used for road making purposes will contain saturates (saturated hydrocarbons, alkanes), aromatic hydrocarbons and resins (maltenes). Thus, asphalt is a highly complex, not well characterized material of varying and often unknown amounts of saturated and unsaturated aliphatic and aromatic compounds and resins. Any asphaltene in asphalt is typically highly dispersed in the maltenes. Asphaltenes, on the other hand, are a specific component of and obtained from dilution of crude oil or petroleum. Asphaltenes, obtained from crude oil, are identified as that which is insoluble (precipitates) in an n-alkane (e.g., n-pentane, n-heptane) and will re-dissolve in toluene. Maltenes are soluble in n-heptane. Even with addition of maltenes to the described asphaltene precipitate, it is understood that such an addition will not provide an asphalt, because asphalt is obtained in an alternative and different process after fractionation/refining of crude oil.

In some forms, the asphaltene described will be pure asphaltene. In some forms, the asphaltene may have some maltenes. The maltenes amount may be negligible or may be up to or greater than 10%. It has been found that no or negligible amounts of maltenes may be preferred when preparing compositions described herein for use in cold climates, particularly climates that see temperatures at or below freezing. As as alterantive, in some embodiments, a small amount of maltenes may be added to the initial asphaltene, which may increase flexibility of the asphaltene based composition. Often, the initial asphaltene may include very little maltenes (e.g., as low as 2% or less or none). In such instances, when desired, maltenes may be added to comprise more than 2% of the total asphaltene, or about 5% of the total asphaltene, or the maltenes may be added to comprise about 10% of the total asphaltene, or may be added to comprise about 15% of the total asphaltene, or may be added to comprise about 20% of the total asphaltene. In some embodiments, the maltenes amount may be up to 30%. For example, when the initial maltenes amount in the asphalene is low, such as less than 2%, an amount of maltenes may be added, such as 8% to provide a maltenes of amount of about 10%. It is understood that adding maltenes in the manner described does not then form an asphalt. Maltenes, when added, may be provided to the asphaltene tank or at a later time during processing, such as when the asphaltene is batched with a peptizer, or just prior to milling for particle dispersion (e.g., prior to colloidal milling), or by adding in a solution with a surfactant prior to emulsification. Maltenes, when added, are typically included at a temperature of between about 300 to 375° F. In some instances, the temperature may be about 325° F. Thus, the asphaltene described herein generally has only a small amount of saturates and olefins, about 20% or less, or about 15% or less, or about 10% or less, or about 5% or less, or about 2% or less, or may be less than 2% or nearly negligible amount. In some forms, the asphaltene may include some amount of ash, mineral and/or clay fines.

Generally, a suitable asphaltene has a penetration grade (pen) of about or less than 35 or 25 or less or 20 or less or 0. While 25 pen or higher may be used, the composition described herein when formed may not be as good in quality or offer the same performance characteristics due to a lower ability of a higher pen composition to combine with light hydrocarbons in the waste cuttings.

In forming an asphaltene based composition described herein, the asphaltene used is often initially provided in a more semi-solid or hardened state and must be softened by heating. The heating temperature is typically about 300° F. or about 325° F. or about 350° F. or about 375° F. or may be slightly greater. Less suitable are temperatures below 300° F. Much higher temperatures that promote coking are avoided.

The asphaltene based composition described herein may include at least one surfactant. The surfactant may be ionic (anionic, cationic, zwitterionic) or non-ionic. Ionic surfactants may include anions (e.g., sulfate, sulfonate, phosphate, carboxylate) or cations (e.g., primary, secondary, tertiary or quaternary amines or quaternary ammonium) or combinations thereof. Non-ionic surfactants may include fatty alcohols, glycols (e.g., polyethylene, polypropylene, polyoxyethylene, polyoxypropylene), glucosides, glycerols, and sorbitans, as examples. Generally, any suitable surfactant that is amphiphilic and adsorbs at a liquid-oil interface is acceptable for use. In some embodiments, a cationic surfactant is useful due to its reduced ability to re-wet. When a surfactant is present in the drilling fluid of the waste cuttings, the amount of surfactant provided in the composition described herein is generally not altered because the amount in the drilling fluid is not generally large enough to require an adjustment. When the amount of surfactant in the drilling fluid is sufficiently large, the surfactant amount in the asphaltene based composition may be suitably adjusted.

The asphaltene based composition described herein may include at least one peptizer. The peptizer is generally or includes a polar, nitrogen-based resin or wetting agent. The peptizer will couple with and may hydrogen bond to the asphaltene and may also prevent asphaltene aggregation or insolubility. In one or more embodiments, a peptizer may include a liquid rosin (e.g., tall oil, extracted tall oil, fatty acids of tall oil), black liquor (from a wood pulping process), and green liquor (from a wood pulping process), and variations thereof. A synthetic peptizer is also suitable. The peptizer may also behave as an emulsifier or dispersant. Both safe and less safe resinous dispersing agents may be used, as appropriate. A safer resinous dispersing agent is selected and/or preferred when the asphaltene based composition is prepared to meet one or more environmental and/or safety requirements or standards.

The asphaltene based composition described herein may include at least one light end hydrocarbon diluent. The light end hydrocarbon diluent or solvent includes hydrocarbons containing short chains, generally C1-C5, such as methane (C1), ethane (C2), propane (C3), butane (C4), pentane (C5), as may be contained in liquified petroleum gas, gasoline, and some diesel oils, as examples. In one or more forms, the light end hydrocarbon diluent or solvent is naphtha that includes the lightest (generally C5 to C6 or C5 to C12), volatile fraction of liquid hydrocarbons in crude oil or petroleum. When needed or desired, benzene, toluene or other similar short chain hydrocarbons or a fuel cutbacks or cutter may be supplemented or used as a replacement. A safer light end hydrocarbon diluent is selected and/or preferred when the asphaltene based composition is prepared to meet one or more environmental and/or safety requirements.

Introduction of the light end hydrocarbon diluent to the asphaltene based composition described herein increases the affinity of hydrocarbons in the waste cuttings with the described asphaltene based composition. It is noted that when the asphaltene based composition described herein is prepared to meet one or more environmental or water safety requirements, naphtha or a similar safe or cleaner light end hydrocarbon diluent is selected and/or preferred. To meet one or more environmental or safety requirements, a fuel cutback or cutter stock is not preferable because of the higher toxicity.

In preparation and prior to blending with waste cuttings, the asphaltene based composition described herein is provided as a mixture. The mixture is generally prepared as a composition comprising at least the asphaltene and peptizer, which may or may not include water. Optionally, one or more surfactants, light end hydrocarbon diluents and/or stabilizers are included in the emulsification or mixture. The properties of the asphaltene and peptizer typically promote the addition of a stabilizer, often in the form of one or more added solvents and/or dispersants. The solvent may be, for example, a light end hydrocarbon. Said stabilizer may be the peptizer and may also be similar to or in the form of a dispersant or thickener. Examples include lignin sulfate, gum stabilizer (e.g., xanthum gum, pectin, gelatin, agar agar, guar gum), tree resin (e.g., Vinsol®, registered to Hercules Powder Company, Delaware). A stabilizer is suitable to maintain longevity of the mixture, particularly when the mixture is stored. The mixture may be prepared continuously or in batches. When formed, the mixture may be an aqueous mixture or a non-aqueous emulsion or suspension (blend in the presence or absence of water) having particles that are generally less than 50 microns. The particles may be non-spherical. The particulated composition may be further filtered to remove larger agglomerates.

When formed, the asphaltene based composition mixture typically has a solids content of about 40 wt. % or greater. In some embodiments, the solids content is up to about 50 wt. % or up to about 60 wt. % or up to about 70 wt. % or up to about 75 wt. %. In one of more forms, the solids content is in a range of about 40 wt. % to 70 wt. % or about 50 wt. % to 80 wt. %. The solids content is generally influenced in a large part by the asphaltene content. In some embodiments, the solids content will be the same as or similar to the asphaltene content. Thus, a composition mixture described herein will generally include asphaltene in an amount ranging from about 40 wt. % to 80 wt. %.

In some embodiments and with certain asphaltene and solvent combinations, a peptizer as well as a surfactant may not be essential to the asphaltene based composition. The solvent is often provided in the form of a light end hydrocarbon diluent, which will maintain the asphaltene in an open and non-aggregated form. In the absence of a peptizer, the asphaltene may have fewer available binding sites for contacting hydrocarbons in the waste cuttings, yet be sufficient for use when forming a road based material as will be described. In some forms, one or more aqueous asphaltene based compositions described may include an asphaltene and at least a surfactant.

When formed, the mixture described herein will often be electrically charged. A surfactant included in the mixture may influence an overall electrical charge of the mixture. A cationic surfactant, for example, may improve electrical attraction of the formed composition when added with a negatively charged aggregate for use as a road based material.

The mixture composition once prepared is immediately available for use. The mixture may also be stored, generally at ambient or room temperature. For long-term storage, a suitable stabilizer may be added to the mixture composition. Water-based mixtures may be stored for a year or longer. Solvent-based (non-aqueous) mixtures may likely be stored indefinitely without significant degradation. Solvent-based mixtures are preferable for use in colder climates that reach temperatures near or below freezing. A mixture composition when having an aqueous base may be unsuitable for use if frozen, as the composition will generally crack after freezing. To eliminate freezing, particularly of a non-aqueous mixture, it has been found useful to include, when desired, a water resistant polymer or plastic polymer, such as a styrene-butadiene rubber (SBR) based latex or SBR latex having an acrylic binder. Generally, when added, the plastic polymer is added after the mixture is formed, such as after let down. Optionally, the plastic polymer may be added during processing of the mixture as will be described. The water resistant polymer or plastic polymer is included to increase water resistance of the formed mixture and increase cold temperature flexibility, e.g., plasticity. Generally, the amount added, when included, is between about 1 and 10 wt. %. The amount may be 1 wt. %, or may be 2 wt. %, or may be 3 wt. %, or may be 4 wt. %, or may be 5 wt. % or higher.

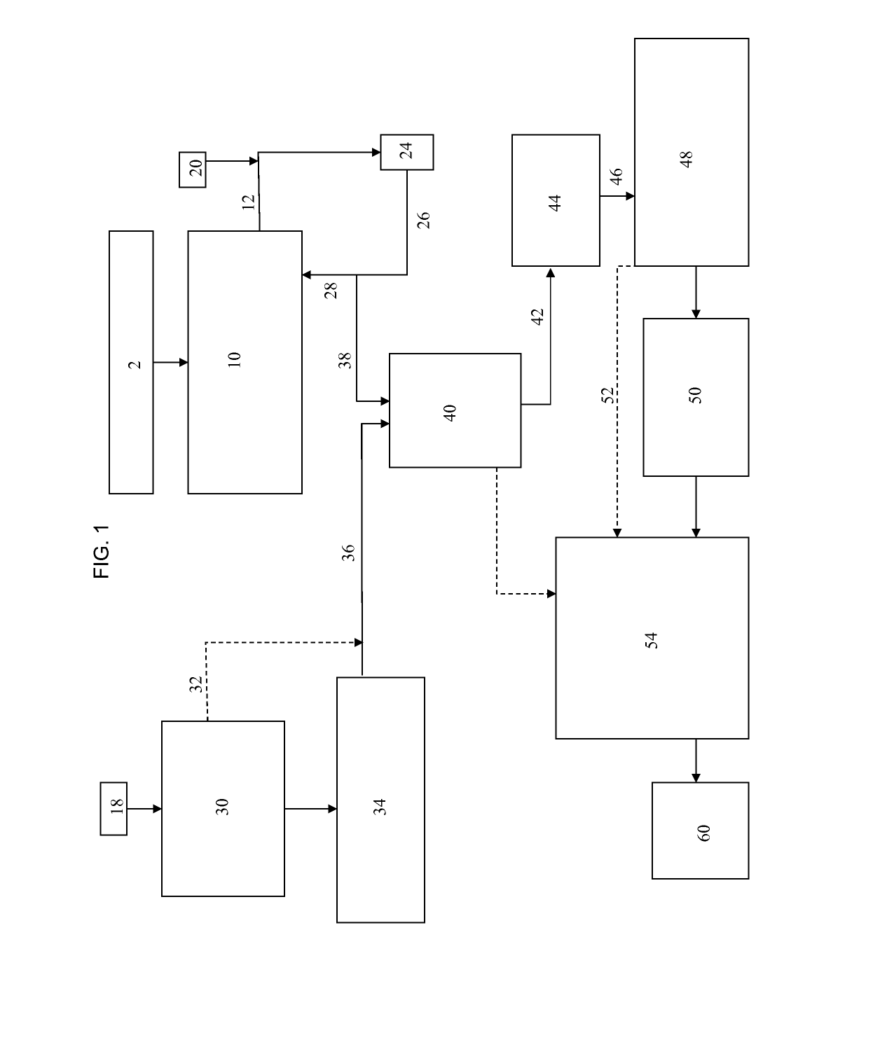

Referring now to FIG. 1, illustrated schematically is an exemplary embodiment for processing an asphaltene based composition described herein, such as an aqueous based composition. Boxes 2, 10, 30, 34, 48 and 54 are containers, such as tanks or vats. For large scale processing, said containers may hold a very large amount of material. Container 2 is a raw material container for the asphaltene. The raw material from container 2 circulates to container 10 by way of one or more pumps and conduits, generally heated, to prevent the asphaltene from solidifying. Container 10 is generally held at an elevated temperature to also prevent the asphaltene from solidifying. The temperature of container 10 is typically from 300 to 375° F. or from 320 to 350° F. The asphaltene may be circulated or gently moved or stirred in its tank. Container 10 may contain asphaltene as well as additional materials. Said additional materials may be introduced, generally, via in-line mixing of material through line 12 to line 26 and to line 28. Thus, in one form container 10 may be similar to a batch tank. Materials from container 10 are introduced and blended with one or more components from box 20. Box 20 may include one component or a number of components, either pre-mixed or each introduced individually. Said components from box 20 will generally include a peptizer and any number of desired accompanying ingredients, such as a surfactant and/or light end hydrocarbons. The one or more components from box 20 are generally introduced slowly to reduce production of steam and excess heat. In an exemplary embodiment, a peptizer or peptizer mixture is introduced. In one or more embodiments said peptizer or peptizer mixture may include one or more fatty acid dispersants, a surfactant and a diluent/solvent. In some embodiments, the one or more components from box 20 are introduced at a rate of about 1 pound every 2 seconds. Combining materials from container 10 and box 20 may include circulating the materials for a period of time. Said period may be up to 15 minutes, or up to 20 minutes or up to 30 minutes or longer.

Materials combined from container 10 and box 20 are further introduced and blended in at least one mixer 24 to form a homogenate. The mixer may be a static blender or homogenizer or inline mixer generally capable of mixing the viscous material with a high degree of mixing in a short length (e.g., using an extrusion, disc, or plate mixer or inline tubes filled with static mixing elements). When more than one mixer is present, they are generally positioned in series. When an inline process is used, the mixers are positioned inline. The homogenate exiting mixer 24 may reenter tank 10 or be channeled to mill 40.

Mill 40 combines all or some of the homogenate via line 38 with components from line 36. Components from line 36 originate as batched ingredients at box 18 that are incorporated into container 30, generally as raw materials, mixtures or combinations thereof. In one or more embodiments a batch mixture is provided. The batch mixture may, in some embodiments include a surfactant, a quaternaryamine, a dispersant, and a diluent/solvent with or without one or more pH modifiers and/or one or more organic alcohols. In one or more embodiments, container 30 is a batch tank or holding tank into which batches of its components are moved to container 34. A batch mixture may be reduced to only a few components or eliminated when preparing a non-aqueous mixture. The batch tank may in some embodiments include an agitator, mixer or eductor. For continuous flow operations, materials from container 30 may be directed to line 36 by way of line 32. Materials in box 18 include but are not limited to one or more surfactants, dispersants, diluents, and/or stabilizers as well as additional ingredients for maintaining pH and stabilization (e.g., sodium hydroxide, hydrochloric acid, etc.). Container 30 is generally maintained at a temperature between about 90° and 125° F., especially for an aqueous mixture. In some embodiments, the temperature may be in a range of between about 105° and 115° F. Container 34, when used, will be maintained at a similar temperature to that of container 30.

Wet milling via mill 40 will homogenize components from line 38 with or without components from line 36. Mill 40 may be a colloid mill, disc mill, jet mill, homogenizer and/or grinder for particle dispersion. The milling may also include ultrasonic milling. The mill will reduce the introduced mixture to particulates, with micron sized solid components. In one form, the particulates are 1 to 50 microns. In some embodiments, the particulates are 5 to 20 microns. Mill 40 is typically run at a temperature based on the temperatures of the homogenate from line 38 and/or the components from line 36.

Generally, a milling temperature will be between about 160° and about 250° F. This contrasts with an asphalt that may require a higher milling temperature to maintain a higher exit temperature.

In one or more embodiments described herein, such as when a colloid mill is used, the milling temperature (temp.) will be based on calculation (1) shown below.

(0.42857×line 38 temp.)+(0.57143×line 36 temp.)+10 (1)

The above calculation includes the presumption that the line 36 temperature is generally between about 90° and 125° F. and the line 38 temperature is generally between about 300° and 375° F. In one or more embodiments, components from line 36 are introduced to mill 40 at a pressure of about 65-100 psi. The milling pressure may be between about 20 and about 60 psi.

The contents in line 42, exiting mill 40, is a mixture containing the described composition. A preferred mixture is smooth when tested between fingers and does not include hard or large agglomerates. A less preferred mixture may feel like sand when tested between fingers. The exiting mixture should have a solids content of about 40%-75% or about 50%-80%. In some embodiments, a mixture, when formed with addition of extra water (aqueous mixture) will have a lower solids content than one formed without addition of extra water (non-aqueous mixture). The solids content can be readily measured by periodic sampling. In one or more embodiments, an increase or decrease in solids content may be adjusted readily by modifying the amount of components entering the mill from line 36. The mixture in line 42 is generally at or near the milling temperature. A noticeable or sudden drop in the temperature of the contents of line 42 may indicate that one or more of the components in either of lines 38 or 36 have been reduced or depleted.

A mixture exiting via line 42 is most often cooled via cooler 44. Cooler 44 may be a liquid cooling system comprising cooling plates or any equivalent. It is generally preferred to keep the mixture exiting cooler 44 at a constant temperature. The cooling described herein is contrary to conventional wisdom when working with the alternative, which is asphalt. When asphalt emulsions are allowed to exit at a high temperature they set on their own, thereby undergoing a slow reduction in temperature. As a result, a higher amount of emulsifier is often used to make a stable asphalt emulsion because more emulsifier is required due to the negative effects of high temperature on the emulsifier in the asphalt emulsion as well as to try to improve binding capability of asphalt (e.g., binding when used for a road-based material). Those making asphalt emulsions generally consider it important to maintain the emulsion at a higher temperature for a longer period of time in order to prolong the chemical interaction between asphalt and emulsifier. Such an understanding is contrary to what is disclosed here.

In one or more embodiments, the mixture described herein when cooled may be moved to container 48, which may be a letdown tank. The letdown tank may include mild agitation. When desired, further dilutions may be made in container 48 or in the let down tank or downstream. For non-aqueous mixtures, after let down, a plastic polymer or water-resistant polymer made be added to increase water resistance and increase cold temperature flexibility. The mixture from container 48 may then move to container 50 or to container 54. Container 50 generally includes a filter assembly to maintain particulates of a desired size. Container 54 is a finished or storage container.

The methods and systems described herein may further include an alarm panel with or without a microprocessor and memory and which cooperates with software that is commercially available or within the skill of practitioners in the programming field. It will be appreciated that the systems and methods described may be implemented by computer program instructions. These computer program instructions may be loaded onto a general purpose computer, special purpose computer, or other programmable data processing apparatus to produce a mechanism, such that, in one form, instructions which execute on the computer or other programmable data processing apparatus create a means for implementing functions and steps described and/or shown. The computer program instructions may also be stored in a computer-readable memory that can direct a computer or other programmable data processing apparatus to function in a particular manner, such that the instructions stored in the computer-readable memory produce the mixture described as well as instruction means that implement the functions specified herein. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified herein. Accordingly, the illustrations shown support combinations of means for performing any combinations of steps and program instruction means for performing one or more specified functions. It will also be understood that with the illustrations, any combination can be implemented by one or more special purpose hardware-based computer systems that perform one or more specified functions or steps, combinations of special purpose hardware and/or computer instructions.

An example of an aqueous mixture was prepared with 0-pen asphaltene, water to which a peptizer mixture, as described below, was incorporated inline. The asphaltene was initially softened at a temperature of about 350° F. The peptizer mixture was added slowly to the asphaltene by first introducing the peptizer with a dispersant and fatty amine to the asphaltene. This was circulated for at least 30 minutes before adding the solvent. Solvent at a typical temperature between 60 and 100° F. was added slowly at a rate of about 1 pound every 2 seconds to prevent evaporation of the solvent (e.g, production of steam). The asphaltene-peptizer combination continued to circulate for at least another 30 minutes. The temperature of the asphaltene-peptizer combination was between about 290 to 335° F. The asphaltene-peptizer combination was then homogenized with a series of static blenders and introduced to a colloid mill. A batch mix was also introduced to the colloid mill. The batch mix included a dispersant, surfactant, quaternary amine, and diluent/solvent. As needed, the batch mix was adjusted with a hydrochloric acid solution that was at a pH of about 3.0 and a temperature of 100 to 110° F. Generally, the pH of the hydrochloric acid was not be greater than 3.4 and was 2.8 or higher. In some embodiments, and as needed, the batch mix was adjusted with a sodium hydroxide solution at a pH of about 8.0 and a temperature of 100 to 125° F. Generally, the pH of the sodium hydroxide solution was not be greater than 8.2 and was 7.8 or higher. The batch mix was prepared by adding each of the ingredients listed in a tank in the order provided. The tank was inline with a heat exchanger to maintain the solution temperature to about 105° F. Flow through the heat exchanger was 20 to 100 psi. The batch mix was introduced to the mill at a pressure of 80 psi. The mill itself had a bearing temperature of 250° F. The mixture after milling was then kept to a temperature of about 150 or greater or up to about 175° F. The after cooler back pressure was between 25 to 35 psi. The after milling solids content was 50 to 65%. When separate runs were performed, solvent was used to clean lines between runs.

An example of an aqueous mixture is depicted in Table 1.

TABLE 1

| | | | Embodiment B |
|---|---|---|---|
| Component | Example | Range (%) | (wt. %) |
| asphaltene | 0-pen to 25-pen | 40-65 | 52 |
| water | | 35-60 | 41 |
| maltene | | 0-30 | |
| Peptizer mix | | | |
| dispersant | fatty acid | 0-2 | 0.24 |
| peptizer | tall oil blend | 0-1 | 0.07 |
| diluent | naptha (C2-C8) | 0.1-5 | 2.5 |
| Batch mix | | | |
| surfactant | cationic detergent | .01-2 | 0.4 |
| dispersant | quaternaryamine | .01-3 | 0.6 |
| stabilizer | lignin sulfonate | .01-3 | 0.6 |
| pH modifier | acid | .01-2 | 0.24 |
| pH modifier | base | 0-1 | 0.02 |
| dispersant | polypropylene glycol | .01-3 | 0.6 |
| diluent | Naptha (C2-C8) | 0.5-4 | 1.5 |

For an aqueous mixture as described above, a representative peptizer mix included a Corsapave from CorsiTech, a Corsimul from CorsiTech and a rule 66 VM&P naptha as a diluent. A representative batch mix included an alcohol ethoxylate (at least or about 70% active) from Harcros Organics, a Redicote from AkzoNobel, a Corsimul from CorsiTech, an about 31.5% solution of hydrochloric acid as an acid, an about 50% solution of sodium hydroxide as a base, polypropylene glycol and a rule 66 VM&P naptha as a diluent.

An example of a non-aqueous mixture was prepared with 0-pen asphaltene in circulation at a temperature of about 300 to 330° F. A peptizer mixture that included the peptizer with a dispersant and fatty amine was added to the asphaltene and circulated for at least 30 minutes before adding a solvent. To prevent evaporation of the solvent, the solvent was added slowly at a rate of about 1 pound every 2 seconds. The asphaltene-peptizer-solvent mixture continued to circulate for at least another 30 minutes. The mixture may be homogenized with a series of static blenders before introduction to a colloid mill. In some embodiments, no initial homogenization is included or required. The mill had a bearing temperature of 250° F. After blending, the mixture was kept to a temperature of about 150 or greater or up to about 175° F. The after cooler back pressure was between 25 to 35 psi. The after milling solids content was 55 to 70%. When separate runs were performed, solvent was used to clean lines between runs.

An example of a non-aqueous mixture is depicted in Table 2.

TABLE 2

| | | | Embodiment A |
|---|---|---|---|
| Component | Example | Range (%) | (wt. %) |
| asphaltene | 0-pen to 25-pen | 65-85 | 71 |
| solvent | naptha (C2-C8) | 15-35 | 25 |
| dispersant | fatty acid | 0.1-5 | 1 |
| surfactant | complex fatty amine salt | 0.5-7 | 2 |
| peptizer | tall oil blend | 0.2-5 | 1 |

For a non-aqueous mixture as described above, a representative embodiment included Corsapave from CorsiTech as a dispersant, Corsabond from CorsiTech as a surfactant, Corsimul from CorsiTech as a peptizer, and a rule 66 VM&P naptha as a representative diluent.

As described herein, the asphaltene based composition when formed does not consist of merely asphalt particles emulsified in water nor is the composition an asphalt emulsion. Thus, the described mixture and composition formed is contrary to what is typically used as road-based asphalt, which is asphalt or emulsified asphalt—neither of which are an asphaltene or an asphaltene based composition as described herein. With the described asphaltene mixture and composition, no additional treatment step or treating agent is required for the described asphaltene composition when formed to be suitably mixed with or interact with waste cuttings and form a road-based material. In addition, the asphaltene composition when formed does not require additional heating before use.

The asphaltene based composition may be prepared in small scale batches or scaled up with out siginficantly altering the amount of components, as evidenced in Table 3 and Table 4.

TABLE 3
Run amount of 1000 gallons

| Component | Pounds | Gallons |
|---|---|---|
| asphaltene | 4912.00 | 585.00 |
| additive A | 5.45 | 0.76 |
| peptizer 1 | 20.27 | 2.49 |
| mixture 1 | 207.47 | 33.63 |
| water | 2881.00 | 345.00 |
| phenol | 33.19 | 4.29 |
| quaternary ammonium chloride | 49.79 | 6.59 |
| stabilizer | 49.79 | 5.82 |
| hydrochloric acid | 19.92 | 2.19 |
| sodium hydroxide | 1.49 | 0.13 |
| glycol | 49.79 | 5.68 |
| mixture 2 | 68.88 | 11.16 |

TABLE 4
Run amount of 10,000 gallons

| Component | Pounds | Gallons |
|---|---|---|
| asphaltene | 49,132.00 | 5849.00 |
| additive A | 54.55 | 7.56 |
| peptizer 1 | 202.77 | 29.94 |
| mixture 1 | 2075.18 | 336.33 |
| water | 28,813.00 | 3455.00 |
| phenol | 332.03 | 42.95 |
| quaternary ammonium chloride | 498.04 | 65.97 |
| stabilizer | 498.04 | 58.25 |
| hydrochloric acid | 199.22 | 21.92 |
| sodium hydroxide | 14.94 | 1.26 |
| glycol | 498.04 | 56.85 |
| mixture 2 | 688.96 | 111.66 |

For the above representative mixtures, a first part combined the asphaltene, first peptizer (e.g., tall oil resin), additive A (e.g., alkyl amine 1), and a first mixture or diluent of the following: benzene, sec-butylbenzene, n-hexane, isopropylbenzene, p-isopropyltoluene, n-propylbenzene, ethylbenzene, toluene, m- and p-xylene, and o-xylene. The first part was then added to the second part, which included the water, phenol, quaternary ammonium chloride, stabilizer (e.g., lignan sulfonate), hydrochloric acid, sodium hydroxide, glycol and the second mixture. The mixture 2 or diluent included the following: benzene, sec-butylbenzene, n-hexane, isopropylbenzene, p-isopropyltoluene, n-propylbenzene, ethylbenzene, toluene, m- and p-xylene, and o-xylene.

The asphaltene based composition when formed is incorporated with waste cuttings. In some embodiments, the waste cuttings may be fresh waste cuttings, or may be stored waste cuttings, or include waste cuttings redistributed into a site or any combination thereof. As such, the waste cuttings may include the addition of earth or soil (e.g., dirt, which may be loamy, clay or sandy in nature). In some embodiments, the waste cuttings, themselves, may be about or less than about 50% or about or less than about 40% or about or less than about 30% or about or less than about 20%, with the balance made up of earth or soil. In such embodiments, the required amount of asphaltene composition may be reduced.

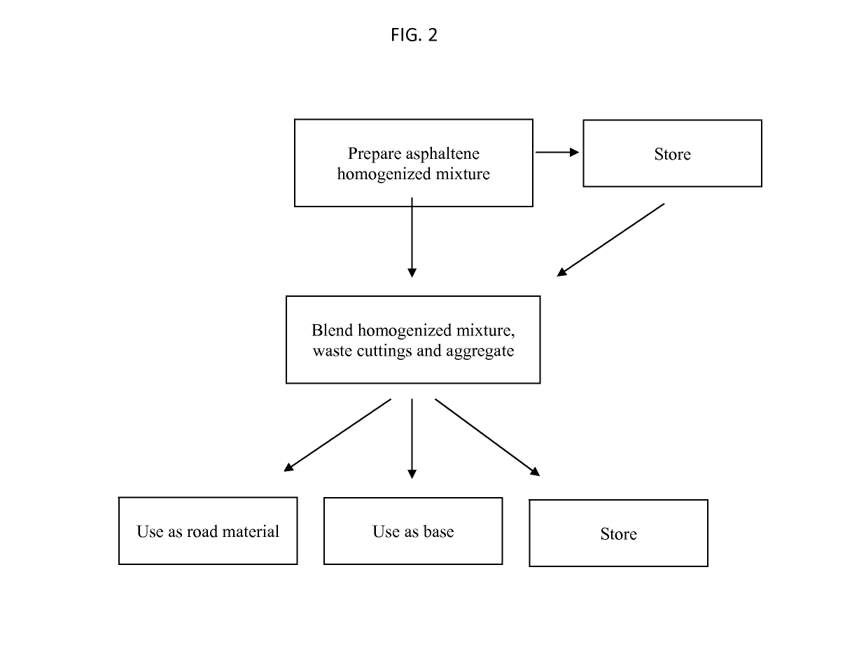

A base material may be incorporated with the asphaltene composition and waste cuttings to form a road based material as depicted in FIG. 2. The road based material when prepared is ready for use or may be made in advance and laid out in sheets, lifts or piles. Said sheets, lifts or piles may also be stacked and the stack may be up to or greater than 50 feet in width by 18 feet tall.

The base, which is added to the cuttings and asphaltene composition, may be or include any suitable base material or aggregate for making a road. Examples include but are not limited to black base (generally ¾ inch rock or shale with or without fines), sand with or without fines, gravel with or without fines, a cold mix (pre-mixed, ready-to use asphalt-mixture), a hot mix (hot asphalt mixture), and, in some instances other concretes, in which asphalt concrete, cement or epoxy act as a binder. The base or binder material may include additional or alternative materials accepted for or capable of use as a road base or subbase by those skilled in the art. The base or aggregate typically offers load bearing strength to the road based material with sufficient strength to meet state and federal requirements. For example, the strength of the road based material described herein may be 35 psi and greater. In some embodiments, a portion of the base, as described, may be substituted with a clay. Generally, not more than 25% of the base is replaced by clay. In some instances, the clay will make up about 10% of the base. In other embodiments, the clay may make up about 15-25% of the base (with the remaining amount as base). The addition of clay, when replacing the base (e.g., gravel or sand) also reduces the total amount of asphaltene that is necessary to be added in order to achieve a desired road based material. The clay may be added separately when blended with the other ingredients or may be combined

For preparation of a road based material described herein, a base or aggregate is added to the described asphaltene composition and cutting. The asphaltene composition is generally in a range of about to 0.05 to about 10% or may be in a range of about 0.1 to about 7% (based on weight). With a reduction in the amount of waste cuttings, the amount of asphaltene composition may also be reduced. Thus, in some embodiments, the amount of asphaltene composition may be about 3-7% or about or less than about 2% or about or less than about 1% or about or less than about 0.05% (based on weight). In many embodiments, the cuttings are greater than 30% of the road-based material by weight. The cuttings are generally in a range of about 20 to about 60% of the road-based material by weight. In some embodiments, the cuttings make up about 25% of the road-based material by weight. The cuttings do not need to be pre-screened for soluble sulfates prior to blending to form the road based material as described. The cuttings also do not require prior screening with regard to the organic material content. The cuttings do not require a drying agent, such as fly ash or kiln dust, prior to use. The cuttings do not require a dilutions step. The cuttings prior to use do not require pre-stabilization or stabilization, such as with a calcium-containing pozzolanic material.

In one or more forms, the asphaltene based composition and cuttings are combined together prior to addition of the aggregate or base material. As an alternative, all road based components, including aggregate, waste cuttings, and asphaltene composition, are combined together (e.g., in series or in parallel). Any suitable mixer may be used to combine the ingredients. In one example, a pug mill or paddle mixer is used. A continuous mixer, batch mixer, concrete mixer, truck mixer, muller type mixer, pan mixer, and drum mixer are additional representative mixers suitable for combining said ingredients.

The described road based material is generally formed at room temperature. No additional heating step is required to prepare the road-based material. The road-based material may then be laid out immediately on a road, laid out on a base or subbase (e.g., rock, sand, or other aggregate), or laid out as a base. Fluids contained in the asphaltene composition and/or the cuttings will evaporate from the blend. The road based material described herein does not require an initial curing of the asphaltene composition and cuttings (sometimes referred to as asphalt stabilization). The road-based material when formed may be prepared in units or sheets and stacked or stored for later use when transported to a desired location. When stored, the formed road base material has a long shelf life, similar to or longer than that of cold mix asphalt.

It has been found that an asphaltene composition prepared with a cationic surfactant works well when formed into a road-based material and laid onto dirt. This is because the asphaltene mixture will have a small electric charge. In lower temperature settings, a solvent-based (non-aqueous) asphaltene mixture may be preferred with or without a surfactant.

Examples of road base materials formulations and corresponding strengths of the formed road based materials after 24 hours are depicted in TABLES 5 and 6. In TABLES 5 and 6, the drill cuttings (C) included a light end hydrocarbon drilling fluid and the base (B) was gravel with fines (a base material suitable for use in accordance with Texas Department of Transportation). TABLE 5 includes an aqueous asphaltene composition (A). The asphaltene composition (A) is based on the weight percent of B+C. In all examples, the materials A, B and C were blended using a lab mixer that simulated pug mill blending for up to about 10 seconds at room temperature. The blended materials were tested after about 24 hours in accordance with ASTM D1559 using the Marshall procedure on each sample.

TABLE 5

| | A wt. % | B wt. % | C wt. % | psi |
|---|---|---|---|---|
| 1 | 0.0 | 75 | 25 | 20 |
| 2 | 0.01 | 75 | 25 | 20 |
| 3 | 0.02 | 75 | 25 | 21 |
| 4 | 0.05 | 75 | 25 | 25 |
| 5 | 0.08 | 75 | 25 | 30 |
| 6 | 0.1 | 75 | 25 | 32 |
| 7 | 0.125 | 75 | 25 | 33 |
| 8 | 0.15 | 75 | 25 | 38 |
| 9 | 0.2 | 75 | 25 | 43 |
| 10 | 0.25 | 75 | 25 | 45 |
| 11 | 0.4 | 75 | 25 | 55 |
| 12 | 0.75 | 75 | 25 | 69 |
| 13 | 1.0 | 75 | 25 | 78 |
| 14 | 1.25 | 75 | 25 | 85 |
| 15 | 1.50 | 75 | 25 | 92 |
| 16 | 1.75 | 75 | 25 | 145 |
| 17 | 2.0 | 75 | 25 | 225 |
| 18 | 2.5 | 75 | 25 | 230 |
| 19 | 3.0 | 75 | 25 | 224 |
| 20 | 3.5 | 75 | 25 | 205 |

Examples of road base formulations and corresponding strengths of the formed road based materials after 24 hours using a non-aqueous asphaltene composition (A) are depicted in Table 6. The asphaltene based composition (A) is based on the weight percent of B+C. In all examples, the materials A, B (base) and C (drill cutting) were blended using a lab mixer that simulated pug mill blending for up to about 10 seconds at room temperature. The blended materials were tested after about 24 hours in accordance with ASTM D1559 using the Marshall procedure on samples.

TABLE 6

| | A wt. % | B wt. % | C wt. % | psi |
|---|---|---|---|---|
| 1 | 0.0 | 75 | 25 | 20 |
| 2 | 0.01 | 75 | 25 | 20 |
| 3 | 0.02 | 75 | 25 | 20 |
| 4 | 0.05 | 75 | 25 | 21 |
| 5 | 0.08 | 75 | 25 | 28 |
| 6 | 0.1 | 75 | 25 | 30 |
| 7 | 0.125 | 75 | 25 | 32 |
| 8 | 0.15 | 75 | 25 | 36 |
| 9 | 0.2 | 75 | 25 | 40 |
| 10 | 0.25 | 75 | 25 | 43 |
| 11 | 0.4 | 75 | 25 | 52 |
| 12 | 0.75 | 75 | 25 | 64 |
| 13 | 1.0 | 75 | 25 | 73 |
| 14 | 1.25 | 75 | 25 | 80 |
| 15 | 1.50 | 75 | 25 | 103 |
| 16 | 1.75 | 75 | 25 | 176 |
| 17 | 2.0 | 75 | 25 | 234 |
| 18 | 2.5 | 75 | 25 | 254 |
| 19 | 3.0 | 75 | 25 | 268 |
| 20 | 3.5 | 75 | 25 | 284 |

To increase psi of the formed road-based material, in some embodiment, the concentration of asphaltene based composition and/or cuttings is increased. In addition, or as an alternative, the psi may be increased by addition of a cementitious binder, such as Portland cement, fly ash or lime or any similar binder material. Thus, when blending with a suitable mixer, such as a pug mill mixer, the cementitious binder will be added as a separate component in addition to the drill cutting, base and asphaltene based composition. Generally, addition of a cementitious binder will replace a portion of the asphaltene based composition. In some embodiments, the asphaltene based composition may be reduced by as much as 50% with addition of a cementitious binder.

The asphaltene compositions when in contact with the waste cuttings have been found not only to behave as a coating, (partially or fully coating cuttings components), but to alter structurally the hydrocarbon components in the cuttings, reducing their volatility and leachability rather than merely encapsulating (stabilizing in its same form without further modification, as offered by alternative concrete solidification processes). Structural changes herein include forming longer chain hydrocarbons upon blending (e.g., by adsorption and molecular changes), hence, behaving as a true structural stabilizer. The asphaltene compositions described herein promote a higher binding with and negligible leaching of the drill cutting waste. The asphaltene based composition when combined with drill cutting is also believed to bind heavy metals, thereby removing them so said heavy metals do not leach from the final composition. As a result, road based materials formed from asphaltene compositions described herein are not associated with leaching, as are road based materials formed by alternative solidification processes, including those that incorporate asphalt or an asphalt emulsion.

The road based material, when formed as described herein, may be used to provide a penetration grade of 5 or 10 or 30 or greater or 65+, many of which are values obtained by other road materials. The road-based materials described herein, thus, allow for re-use of drill cuttings waste, preventing its high cost disposal and/or less satisfactory solidification processes often associated with disposal (land filling) rather than re-use. The road-based materials described herein are not required to be solidified with a separate binder material or hardenable material (e.g., calcium-based pozzolan that form a cementitious or cementitious-like structure) as is the common practice for solidification used by others. It is possible, however, to include a cement binder or to replace the aggregate with a cement binder.

The asphaltene compositions, themselves, as described herein do not require a solid for additional stabilization (as is often required with alternative process that use a pulverized or powdered or dust-form of a calcium-based pozzolanic stabilizer in an amount of about or less than 10% when mixing with the drill cuttings). Thus, when forming the road-based materials described herein, there are no calculations required for adding a calcium-based pozzolanic stabilizer.

To meet state or federal water and road safety requirements, components of asphaltene composition and aggregate may be readily adjusted.

In use, the road-based material described herein containing waste cuttings is suitable for high and low traffic roads, oil roads, black top, as a patch mix or may, itself, serve as a road base. The asphaltene composition as well as the road-based material described herein may both be readily modified for small and large scale production.

Although representative processes and articles have been described in detail herein, those skilled in the art will recognize that various substitutions and modifications may be made without departing from the scope and spirit of the invention as described and defined by the appended claims.

What is claimed is:

1. An asphaltene composition comprising:
an asphaltene, wherein the asphaltene is the insoluble component or precipitate after dilution of crude oil with an n-alkane;
a surfactant; and
a peptizer, wherein the peptizer includes or acts as a solvent,
wherein the composition is provided as an aqueous or non-aqueous homogenized mixture.

2. The composition of claim 1 further comprising light end hydrocarbons.

3. The composition of claim 1 wherein the asphaltene comprises 50% to 80% of the composition by weight.

4. The composition of claim 1, wherein the asphaltene is about 20 pen or less.

5. The composition of claim 1, wherein the asphaltene composition is stable at room temperature.

6. The composition of claim 1, wherein the peptizer is a nitrogen-based resin or a liquid rosin.

7. The composition of claim 1, wherein the asphaltene composition is not an emulsion.

8. The composition of claim 1, wherein the asphaltene composition is milled to form particulates of 1 to 50 microns.

9. The composition of claim 1 further comprising naptha.

10. An asphaltene composition comprising:
an asphaltene, wherein the asphaltene is the insoluble component or precipitate after dilution of crude oil with an n-alkane; and
a surfactant,
wherein the composition is provided as an aqueous or non-aqueous homogenized mixture.

11. The composition of claim 10 further comprising light end hydrocarbons.

12. The composition of claim 10 wherein the asphaltene comprises 50% to 80% of the composition by weight:

13. The composition of claim 10, wherein the asphaltene is about 25 pen or less.

14. The composition of claim 10, wherein the surfactant is a cationic surfactant.

15. The composition of claim 10 further comprising a peptizer in the form of a nitrogen-based resin or a liquid rosin.

16. The composition of claim 10 further comprising naptha.

17. The composition of claim 10, wherein the composition is stable at room temperature.

18. An asphaltene composition comprising:
an asphaltene, wherein the asphaltene is the insoluble component or precipitate after dilution of crude oil with an n-alkane; and
a peptizer, wherein the peptizer includes or acts as a solvent,
wherein the composition is provided as an aqueous or non-aqueous homogenized mixture.

19. The composition of claim 18 further comprising light end hydrocarbons.

20. The composition of claim 18, wherein the asphaltene comprises 50% to 80% of the composition by weight:

21. The composition of claim 18, wherein the asphaltene is about 25 pen or less.

22. The composition of claim 18 further comprising a cationic surfactant.

23. The composition of claim 18, wherein the peptizer is a liquid rosin.

24. The composition of claim 18, wherein the peptizer in the form of a nitrogen-based resin.

25. The composition of claim 18, wherein the composition is milled to form particulates of 1 to 50 microns.

26. The composition of claim 18 further comprising naptha.

27. A method of making an asphaltene composition comprising the steps of:
combining at an elevated temperature an asphaltene with at least a peptizer, wherein the asphaltene is the insoluble component or precipitate after dilution of crude oil with an n-alkane;
circulating the combination while maintaining heat; and
blending to form a homogenized mixture with particulates of 1 to 50 microns.

28. The method of claim 27 further comprising adding a solvent at an elevated temperature.

29. The method of claim 27 further comprising cooling the homogenized mixture after exiting.

30. A composition for use as a road-based material comprising:
an asphaltene mixture, wherein the asphaltene mixture is a homogenized mixture that includes asphaltene as an insoluble component or precipitate after dilution of crude oil with an n-alkane;
waste cuttings from a drill site; and
one or more aggregates, wherein the one or more aggregates are or include a black base, sand, gravel, an asphalt concrete mix, cement or an epoxy binder.

31. The composition of claim 30, wherein the asphaltene mixture further comprises one or more of the group consisting of peptizer, surfactant, stabilizer, and light end hydrocarbon.

32. The composition of claim 30, wherein the waste cuttings include one or more of a water, oil or polymer-based drilling fluid.

33. The composition of claim 30, wherein the asphaltene mixture is provided in an amount between about 0.05wt. % and 10 wt. %.

34. The composition of claim 30, wherein the composition is used for one or more of a high and low traffic road, oil road, black top, as a patch mix and a road base, suitable for use in a high temperature and a low temperature environment.

35. The composition of claim 30, wherein the composition is laid out in sheets, lifts or piles.

36. The composition of claim 30, wherein the composition may be stored.

37. The composition of claim 30, wherein the composition further comprises clay.

38. A method of making a road-based material comprising the step of:
combining an asphaltene mixture, waste cuttings from a drill site and one or more aggregates,
wherein the asphaltene mixture is a homogenized mixture that includes asphaltene provided initially as an insoluble component or precipitate after dilution of crude oil with an n-alkane, and
wherein the one or more aggregates are or include one or more of a black base, sand, shale, gravel, clay, cementitious binder, an asphalt concrete mix, cement or epoxy binder.

39. The method of claim 38, wherein combining includes adding in a mixer.

40. The method of claim 38, wherein combining is adding to one of the group consisting of pug mill, paddle mixer, continuous mixer, batch mixer, concrete mixer, truck mixer, muller type mixer, and pan mixer.

41. The method of claim 38, wherein combining is at ambient temperature.

42. The method of claim 38, wherein the waste cuttings are provided in a range from about 20% to about 60%.

43. The method of claim 38, wherein the asphaltene mixture is provided in a range from about to 0.05 to about 10%.

44. A system for preparing a road-based material comprising:
an asphaltene mixture, wherein the asphaltene mixture is a homogenized mixture that includes asphaltene provided initially as an insoluble component or precipitate after dilution of crude oil with an n-alkane;
waste cuttings from a drill site;
one or more aggregates, wherein the one or more aggregates are or include one or more of a black base, sand, shale, gravel, clay, cementitious binder, an asphalt concrete mix, cement or epoxy binder; and
a mixer.

45. The system of claim 44, wherein the system is provided on location.

46. The system of claim 44, wherein the waste cuttings do not require additional treatment prior to use.
